(19) United States
(12) Patent Application Publication
(10) Pub. No.: US 2026/0273444 A1
(43) Pub. Date: Sep. 17, 2026

(54) TRAP DEVICE

(71) Applicant: Kioxia Corporation, Tokyo (JP)

(72) Inventors: Shusaku MATSUMOTO, Saitama Saitama (JP); Hiroshi MATSUBA, Fujisawa Kanagawa (JP); Akihito NOGUCHI, Yokohama Kanagawa (JP)

(21) Appl. No.: 19/322,354

(22) Filed: Sep. 8, 2025

(30) Foreign Application Priority Data
Mar. 17, 2025 (JP) 2025-042847

(51) Int. Cl. B01D 45/08

(52) U.S. Cl. CPC B01D 45/08

(57) ABSTRACT

According to one embodiment, a trap device includes a trap tank wall surrounding an interior space, a tank-internal pipe extending into the interior space from an inlet side and having a first opening into the interior space, and an inner vessel in the interior space. The inner vessel has a bottom surface between the first opening and an outlet side, and a side-wall that extends toward the inlet side from the bottom surface and forms a second opening at a position along the first direction that is the same or closer to the inlet side than is the first opening. A gas flow space is provided between trap tank wall and the inner vessel to permit indirect gas flow from the second opening portion to the outlet side.

### CROSS-REFERENCE TO RELATED APPLICATIONS

This application is based upon and claims the benefit of priority from Japanese Patent Application No. 2025-042847, filed Mar. 17, 2025, the entire contents of which are incorporated herein by reference.

### FIELD

Embodiments described herein relate generally to a particle trap device.

### BACKGROUND

There is a device that can be provided in a fluid or gas discharging path for collecting particles from the fluid or gas.

### BRIEF DESCRIPTION OF THE DRAWINGS

FIG. 1 is a block diagram illustrating an example configuration of a system to which a trap device of an embodiment can be applied.

FIG. 2 is a diagram illustrating a configuration of a trap device of an embodiment.

FIG. 3 is a cross-sectional view at III-III of FIG. 2.

FIG. 4 is a diagram illustrating a configuration of an inner vessel and its vicinity.

FIG. 5 is a schematic diagram illustrating aspects of the behavior of a gas in a trap device of an embodiment.

FIG. 6 is a diagram illustrating a configuration of a trap device according to a modification example.

FIG. 7 is a cross-sectional view at VII-VII of FIG. 6.

FIG. 8 is a diagram illustrating a configuration of a trap device according to another modification example.

FIG. 9 is a cross-sectional view at IX-IX of FIG. 8.

FIG. 10 is a diagram illustrating a configuration of a trap device according to a still further modification.

FIG. 11 depicts a schematic model of a trap device of an example embodiment.

FIG. 12 depicts a schematic model of a trap device of a comparative example.

FIG. 13 is a plan view of the trap device of the comparative example.

FIG. 14 is a schematic diagram illustrating behavior of particles in the trap device of the comparative example.

### DETAILED DESCRIPTION

According to an embodiment, a trap device with an improved collection efficiency for particles is provided.

In general, according to one embodiment, a trap device includes a trap tank wall portion surrounding an interior space. The trap tank wall portion has an inlet side and an outlet side. A tank-internal pipe portion extends from the trap tank wall portion into the interior space from the inlet side. The tank-internal pipe portion has a first opening portion that opens into the interior space. An inner vessel is in the interior space. The inner vessel includes a bottom portion with a bottom surface that faces the first opening portion. The bottom surface is spaced from the first opening portion in a first direction but is between the first opening portion and the outlet side. The inner vessel also includes a side-wall portion that extends toward the inlet side from the bottom surface and forms a second opening portion at a position along the first direction that is the same or closer to the inlet side than is the first opening portion. A gas flow space is provided between trap tank wall portion and the inner vessel to permit indirect gas flow from the second opening portion to the outlet side.

Certain example embodiments will now be described with reference to attached drawings. For ease of understanding of the description, substantially similar components or aspects in the different drawings will be given the same reference symbol and, in such cases, repeated description of such components or aspects may be omitted from the description of subsequent drawings after an initial description.

### 1. Embodiment

### 1-1. Overall Configuration of System

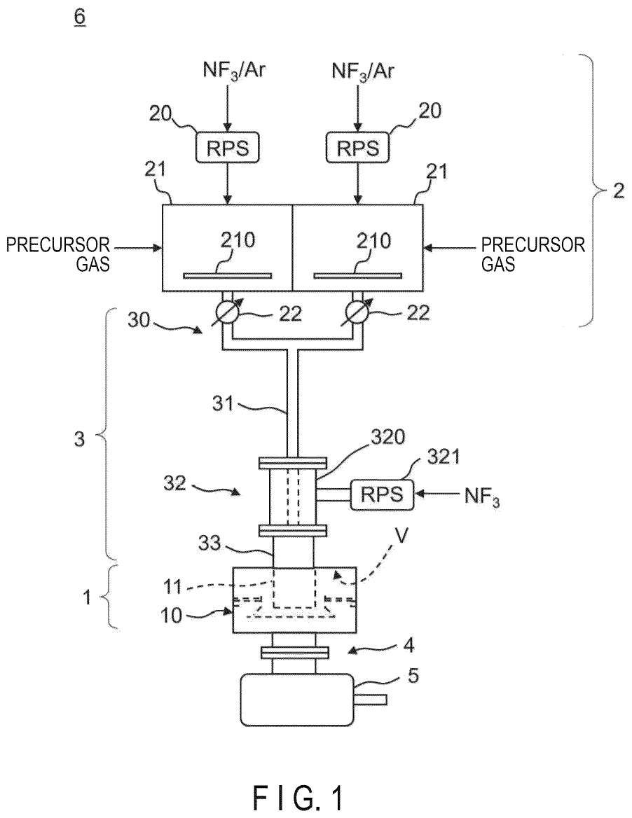

FIG. 1 is a block diagram illustrating an example configuration of a system 6 to which a trap device 1 of an embodiment is applied. In the example illustrated in FIG. 1, the system 6 is arranged as a film-forming system for semiconductor devices. The system 6 includes a film-forming device 2, piping systems 3 and 4, the trap device 1, and a pump device 5. The film-forming device 2 and the trap device 1 are connected by the piping system 3. The trap device 1 and the pump device 5 are connected by the piping system 4. A flow path for gas through the system 6 is formed by these components, with the film-forming device 2 being on the upstream (inlet) side and the pump device 5 being on the downstream (outlet) side.

The film-forming device 2 is a device for forming a desired film on a surface of a semiconductor substrate. In the example in FIG. 1, the film-forming device 2 includes two remote plasma source devices 20 (hereinafter, referred to as “RPS devices 20”), two film-forming chambers 21 each respectively located on the downstream side of one of the RPS device 20, and two pressure regulating valves 22. Each film-forming chamber 21 is controlled to reach a predetermined internal pressure by the respective pressure regulating valve 22 connected to the film-forming chamber 21, while vacuum is applied by the pump device 5 thereto. A semiconductor substrate 210 on which a film is to be formed can be placed in each film-forming chamber 21. A precursor gas is supplied into the film-forming chambers 21 to form a desired film on the semiconductor substrate 210 by a chemical reaction of the precursor gas or the like. The precursor gas is, for example, tetraethyl orthosilicate (TEOS) and the generated film is, for example, silicon oxide (SiO₂). Generally, the tetraethyl orthosilicate gas is supplied along with oxygen (O₂) gas to the film-forming chamber 21.

Generally, in such a film-forming process, by-products are generated due to reactions of the precursor gas. These by-products may deposit on surfaces in the film-forming chamber 21 and may also deposit along the piping system 3 and in the inside of the pump device 5. Deposits in the inside of the pump device 5 may eventually cause an overload condition of the pump device 5. An overload condition may cause abnormal shutdown or malfunction of the pump device 5.

The RPS device 20 can be supplied with a cleaning gas, such as nitrogen trifluoride (NF₃) gas, and a purge gas, such as argon (Ar) gas. The RPS device 20 generates fluorine (F) radicals by means of plasma generation. When the generated fluorine radicals are supplied to each film-forming chamber 21 or to the piping system 3, deposits are decomposed and highly volatile compounds (for example, silicon tetrafluoride) are generated. Accordingly, the accumulation of deposits can be suppressed or reduced. However, tetraethyl orthosilicate, which is a precursor gas, and nitrogen trifluoride, which is a cleaning gas, may also react with each other to generate reaction products. In this context, these reaction products are those that secondarily or unintentionally generated in the system 6. These reaction products may also cause an overload condition of the pump device 5 and will be referred to as particles.

To efficiently collect such particles, the trap device 1 is provided in the flow path for gas through the system 6. The trap device 1 is connected on the downstream side of the film-forming device 2 and on the upstream side of the pump device 5. That is, the trap device 1 is provided in the flow path for gas in the system 6 with the film-forming device 2 on the upstream side and the pump device 5 on the downstream side.

More specifically, each film-forming chamber 21 of the film-forming device 2 is on the upstream side of the trap device 1 and is connected thereto through the piping system 3. In the example illustrated in FIG. 1, the piping system 3 includes a branching portion 30, a merging portion 31, a cleaning portion 32, and a tank-external pipe portion 33. The branching portion 30, the merging portion 31, and the tank-external pipe portion 33 can be formed from any known piping materials. Piping materials include, for example, a stainless-steel material. The branching portion 30 is a bisected tubular portion that is communicably connected to each film-forming chamber 21. The merging portion 31 is a converged tubular portion where branches of the branching portion 30 merge/meet. The merging portion 31 can be formed in an integral manner with the branching portion 30. The cleaning portion 32 is a component for further improving the effect of the cleaning process described above and includes a pipe system 320 and an RPS device 321. The pipe system 320 is connected to the merging portion 31 and the tank-external pipe portion 33 by means of a flange. The pipe system 320 includes an induced-matter pipe that connects with the merging portion 31 and the tank-external pipe portion 33. The RPS device 321 generates plasma in the induced-matter pipe to generate fluorine radicals. Note that the cleaning portion 32 may be supplied with additional nitrogen trifluoride gas and the like by direct connection or the like. The tank-external pipe portion 33 is a tubular portion that is connected to the cleaning portion 32 and the trap device 1 and includes a flange on one side thereof. Note that the tank-external pipe portion 33 may be formed in an integral manner with a trap tank 10. That is, the trap device 1 may include the tank-external pipe portion 33 as portion thereof instead of the external pipe portion 33 being a sub-component of piping system 3.

As described above, the piping system 3 forms an introducing path for introducing the gas into an inner space V of the trap device 1. However, the specifics of the configuration of the piping system 3 is not particularly limited, and various modification thereto can be made as necessary or appropriate for particular operations or scenarios. For example, the cleaning portion 32 may be omitted in some cases and the tank-external pipe portion 33 can be connected directly to the merging portion 31. In this case, the merging portion 31 and the tank-external pipe portion 33 may be formed in an integral manner with each other.

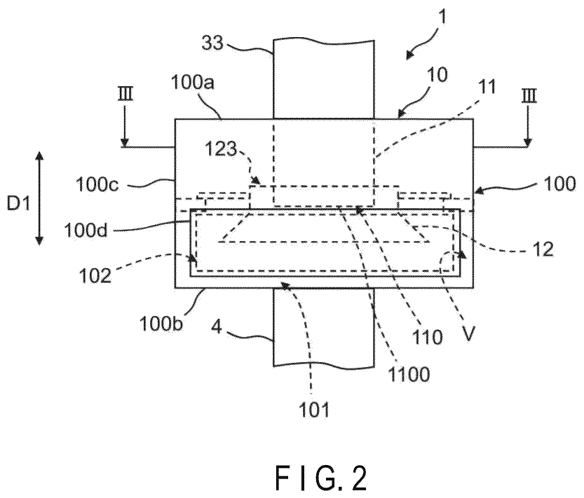

The trap device 1 is connected to the pump device 5 through the piping system 4 on the downstream side. The gas after particles have been collected by the trap device 1 then enters into the piping system 4. In other words, the piping system 4 forms a discharging path for discharging gas from the inner space V of the trap device 1. Here, for facilitating description, a portion forming a path for gas from the outer surface of a bottom-wall portion 100b of the trap tank 10 (see FIG. 2) up to a connected portion with the pump device 5 is referred to as the piping system 4. However, in some examples, the trap device 1 may be formed in an integral manner with the trap tank 10 and include a discharging pipe projecting from the outer surface of the bottom-wall portion 100b. In this case, the discharging pipe may be formed as a flanged pipe to be connected to another pipe. As described above, the configuration of the piping system 4 is not particularly limited, and various modification can be made as necessary or appropriate. The piping system 4 can be formed from any known piping materials. For example, a stainless-steel material is used.

Typically, the pump device 5 is a vacuum pump. The type vacuum pump adopted is not particularly a limitation and any type may be used as long as an appropriate vacuum can be applied to the film-forming chambers 21.

### 1-2. Configuration of Trap Device

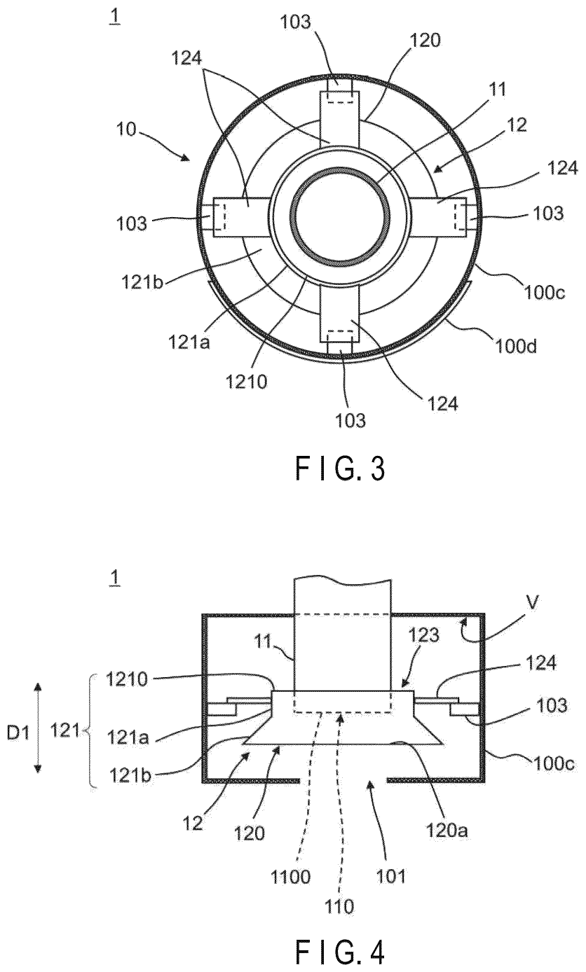

FIG. 2 is a side view of the trap device 1, and FIG. 3 is a III-III sectional view of FIG. 2. In FIG. 2, the trap device 1 includes a trap tank 10, a tank-internal pipe portion 11, and an inner vessel 12. The trap tank 10 includes a wall portion 100 that forms the inner space V in which gas is allowed to flow. The wall portion 100 includes a top-wall portion 100a, the bottom-wall portion 100b, and a side-wall portion 100c, and forms a substantially hollow-cylindrical shape. The top-wall portion 100a and the bottom-wall portion 100b are opposite to each other in a first direction D1 with a space in between. The tank-external pipe portion 33 extends to the outside of the trap tank 10 from the top-wall portion 100a, and the tank-internal pipe portion 11 extends into the inner space V from the top-wall portion 100a. An opening 101 for discharging gas from the inner space V is formed in the bottom-wall portion 100b. The piping system 4 extends to the outside of the trap tank 10 from the circumferential edge of the opening 101. While in FIG. 2, the first direction D1 coincides with the up-down direction, the first direction D1 is not limited to being the vertical direction. In other words, the trap device 1 may be used in such a posture that the first direction D1 does not coincide with the vertical or gravitational direction. In the trap device 1 according to the embodiment, the tank-internal pipe portion 11 and the piping system 4 are arranged coaxially with each other or substantially coaxially with each other.

The side-wall portion 100c extends between the top-wall portion 100a and the bottom-wall portion 100b. An opening 102 is formed in the side-wall portion 100c. While the opening 102 functions as a retrieval port for the inner vessel 12, it is normally covered (closed) with a lid 100d when the trap device 1 is in use. For example, the lid 100d is made of a material same as that of the side-wall portion 100c and is fastened with screws, bolts, or the like (though such fasteners are not specifically illustrated) to a circumferential edge portion of the opening 102. Accordingly, the wall portion 100 of the trap tank 10 can be said to include or comprise the lid 100d. The configuration of the lid 100d is not particularly limited, and, for example, it may be formed as a plate that has a curvature matched to the curvature of the side-wall portion 100c. Alternatively, the lid 100d may be hinged or otherwise attached to the side-wall portion 100c as a door that opens and closes the opening 102 by being rotated about the hinge or the like. Furthermore, the lid 100d may include or incorporate a sealing mechanism (for example, gasket) for preventing a gas leak from the inner space V.

The tank-internal pipe portion 11 is a tubular portion that connects to the tank-external pipe portion 33 and extends from the top-wall portion 100a to the first direction D1 to form a flow channel for gas. That is, the flow channel for gas passes through the top-wall portion 100a. In FIG. 2, the tank-internal pipe portion 11 includes an open-end portion 110, which is an end portion that opens within the inner space V. The open-end portion 110 functions as an exit for the tank-external pipe portion 33 and the tank-internal pipe portion 11. The open-end portion 110 is an example of a “first open-end portion” of the present disclosure. In the open-end portion 110, a plane in which the circumferential edge of the opening is present and which is orthogonal to the first direction D1 is referred to as an end face 1100.

FIG. 4 is a side view illustrating a configuration of the inner vessel 12 and its vicinity. The inner vessel 12 is disposed in the inner space V and has a shape such that one end of a tubular side-wall portion is open and the other end is closed (by a bottom portion). With such a shape, the inner vessel 12 receives gas discharged from the open-end portion 110 of the tank-internal pipe portion 11 and serves to collect particles carried by the gas. In the example illustrated in FIGS. 3 to 4, the inner vessel 12 includes a bottom portion 120 that is substantially circular in plan view and a side-wall portion 121 that stands on the bottom portion 120 and extends toward the open-end portion 110. The bottom portion 120 has a bottom surface 120a that faces the open-end portion 110 with a space between in the first direction D1. The inner vessel 12 of this embodiment is disposed such that its central axis (the axis that passes through the center point of the bottom surface 120a and is orthogonal to the bottom surface 120a) coincides or substantially coincides with the central axis of the tank-internal pipe portion 11 and the piping system 4.

The side-wall portion 121 includes a tapered portion 121b that extends from the bottom portion 120 and a cylindrical portion 121a (that has a hollow-cylindrical shape) and extends from the tapered portion 121b in direction D1. The cylindrical portion 121a includes an open-end portion 123 that is substantially circular in plan view. The open-end portion 123 is an example of a “second open-end portion” of the present disclosure. The tapered portion 121b has an increasing diameter from the side of the open-end portion 123 toward the bottom portion 120. Accordingly, the bottom surface 120a has a diameter larger than the inner diameter of the cylindrical portion 121a. A reason for forming the tapered portion 121b in this manner will be described below.

In the open-end portion 123, a plane that includes the circumferential edge of the opening of the inner vessel 12 and is orthogonal to the first direction D1 is referred to as an end face 1210. The trap device 1 of the embodiment is configured such that a region surrounded by the end face 1210 of the open-end portion 123 as projected on a virtual plane perpendicular to the first direction D1 includes the entire end face 1100 of the open-end portion 110 when projected on the same virtual plane. In other words, the inner diameter of the open-end portion 123 in the side-wall portion 121 is larger than the inner diameter of the open-end portion 110 in the tank-internal pipe portion 11. Furthermore, the end face 1210 is located farther away from the bottom portion 120 in the first direction D1 than is the end face 1100 of the open-end portion 110. In other words, the tank-internal pipe portion 11 and the inner vessel 12 are in a positional relationship such that at least a part of a side circumferential surface of the tank-internal pipe portion 11 is surrounded by the side-wall portion 121 of the inner vessel 12 from the outside in the radial direction and faces the inner surface of the side-wall portion 121.

The inner vessel 12 of this embodiment is supported by a support member in the inner space V, but can be removed from the inner space V by operation of the support member or otherwise. The support member in this example is configured such that it includes four support portions 103 formed on the inner surface of the wall portion 100 and four supported portions 124 formed on the outer surface of the side-wall portion 121 of the inner vessel 12. The support portions 103 are each a plate-like component that projects in the inner space V from the side-wall portion 100c of the trap tank 10 and are spaced apart from one another in the circumferential direction. The supported portions 124 are each a plate-like component that projects radially outward from the outer surface of the side-wall portion 121 of the inner vessel 12 and are spaced apart from one another in the circumferential direction. In the example illustrated in FIG. 3, four support portions 103 and four supported portions 124 are arranged to coincide with each other on the respective concentric circumferences. When the supported portions 124 are placed on a corresponding support portion 103, the inner vessel 12 is supported such that the bottom portion 120 of the inner vessel 12 does not come into contact with the bottom-wall portion 100b of the trap tank 10. On the one hand, with the inner vessel 12 being supported in this way, when the inner vessel 12 may still be rotated around its central axis to displace the four supported portions 124 in the circumferential direction relative to four support portions 103, as such the supported state of the inner vessel 12 can easily be released.

With this support member, it is possible to position the inner vessel 12 such that the open-end portion 110 of the tank-internal pipe portion 11 will be located in the inner vessel 12. Furthermore, a space in which gas can flow is provided between the inner surface of the wall portion 100 of the trap tank 10 and outer surfaces of the side-wall portion 121 and the bottom portion 120 of the inner vessel 12.

The materials of the trap tank 10, the tank-internal pipe portion 11, the inner vessel 12, and the support member are not particularly limited. Materials, such as metals, that have corrosion resistance against the gases flowing through the inner space V, are preferable. For example, a stainless-steel material may be used.

### 1-3. Advantageous Effects

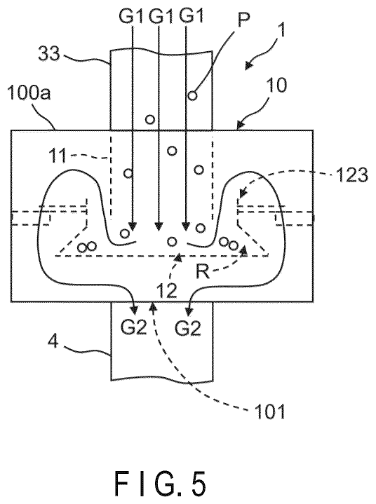

FIG. 5 is a schematic diagram illustrating aspects of the behavior of gas and particles P carried by the gas in the trap device 1 of an embodiment. The gas enters from the tank-external pipe portion 33 to the tank-internal pipe portion 11 in the direction indicated by the arrow Gl. The entering gas is discharged from the open-end portion 110 into the inner vessel 12. Along with this inflow of gas, particles P are also carried into the inner vessel 12. The passage of the entering gas and particles P is obstructed by the bottom surface 120a that faces the open-end portion 110. The gas thus flows into the space between the open-end portion 110 and the side-wall portion 121 due to the pressure difference in the inner vessel 12. The gas ultimately flows out of the inner vessel 12 through the open-end portion 123, as indicated by the arrow G2. The entering particles Pare subjected to an outward force in the radial direction due to the bottom surface 120a blocking a direct downward flow. The particles P are thus collected (or tend to collect) in a region R formed between the bottom portion 120 and the tapered portion 121b. It is conceivable that the particles P might be carried by the flowing gas out of the inner vessel 12 again, however, such a possibility is lowered by the formation of region R. Accordingly, the particles P will tend to be accumulated in the region R. The gas flowing out from the inner vessel 12 flows in the space between the wall portion 100 of the trap tank 10 and the outer surface of the inner vessel 12 and is then discharged into the piping system 4 through the opening 101.

As described above, in the trap device 1 of the embodiment, the gas and particles P are discharged from the open-end portion 110 in the inner vessel 12, and then the flow is obstructed by the bottom surface 120a. In particular, in the trap device 1, since the open-end portion 110 is surrounded by the cylindrical portion 121a of the inner vessel 12, the inner vessel 12 can more reliably receive incoming particles P along with the gas. In addition, a region R, in which the particles P are likely to be accumulated, is formed in the inner vessel 12. According to the trap device 1, therefore, it is possible to improve a collection efficiency of the particles P entering the trap tank 10.

In the trap device 1, the tank-internal pipe portion 11, the inner vessel 12, and the piping system 4 are arranged such that the central axes are aligned with one another. In other words, the gas and particles P discharged from the tank-internal pipe portion 11 pass through the inner vessel 12, but are prevented from immediately reaching the opening 101. Accordingly, the possibility that the particles P entering the trap tank 10 migrate into the piping system 4 through the opening 101 can be lowered.

In the trap device 1, the inner vessel 12 is spaced apart from the top-wall portion 100a and the side-wall portion 100c of the trap tank 10 with a certain sized space left in between. The support members of are formed spaced apart from one another in the circumferential direction, so that the flow of gas out of the inner space V is not fully obstructed. In this way, it is possible to suppress the pressure drop or change caused by the trap device 1

With continuous use of the trap device 1, it is conceivable that so many particles P might be accumulated in the inner vessel 12 that there would be a degradation in the collection efficiency of the trap device 1. However, for the trap device 1 of this example, the inner vessel 12 is formed to be separable (removable) from the trap tank 10 and the opening 102 of the trap tank 10 is configured to be openable and closable by the lid 100d. In this way, it is possible to retrieve the inner vessel 12 from the trap tank 10 as necessary for cleaning or replacement. That is, a retrieved inner vessel 12 can be cleaned and thereafter returned and used again in the trap tank 10 or replaced by a new inner vessel 12.

### 1-4. Modifications of Trap Device

Next, modifications of the trap device of an embodiment will be described. The modifications can be combined as appropriate.

In contrast to the above-described embodiment, the tapered portion 121b and the cylindrical portion 121a need not necessarily be formed in the inner vessel 12. For example, the formation of the tapered portion 121b can be omitted and the inner vessel 12 may be a vessel that has just a hollow-cylindrical shape, or alternatively the cylindrical portion 121a can be omitted and the inner vessel 12 may be a vessel that has a continuously increasing diameter toward the bottom portion 120 for its full length. In other examples, the increase in diameter of the tapered portion 121b is not limited to a linear increase in diameter corresponding to the distance from the bottom portion 120 in the first direction D1, and other shapes or rates of change in diameter with distance may be adopted. For example, an exponential increase may be incorporated

The configuration of the support member may be modified as necessary or appropriate. For example, the number of support portions 103 and supported portions 124 may be varied as necessary or appropriate. The support portion 103 and the supported portion 124 may be configured so as to be incapable of relative rotation when connected. A possible example of such a support member is to form a through hole extending in the first direction D1 in one of the support portion 103 and the supported portion 124 and form a catch portion capable of catching (engaging) the through hole on the other. According to such a support member, the positioning of the inner vessel 12 in the inner space V may be further facilitated.

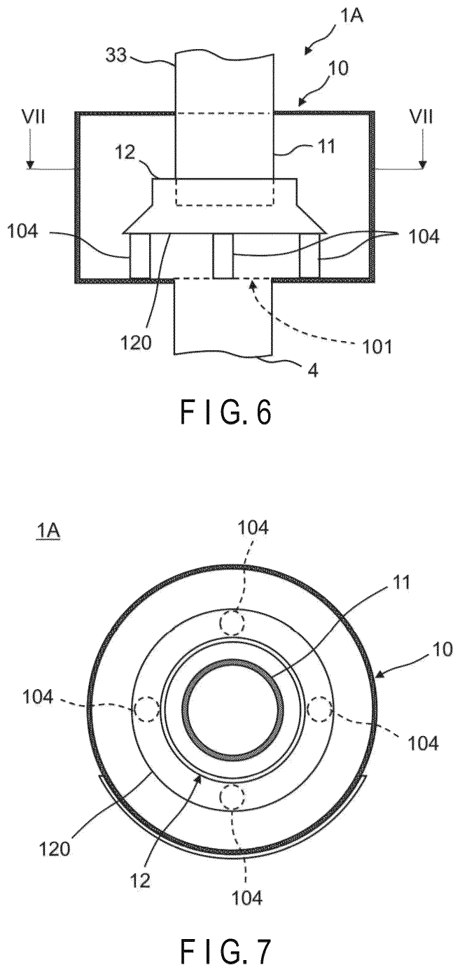

FIG. 6 is a diagram illustrating a configuration of a trap device 1A according to a modification, and FIG. 7 is a VII-VII sectional view of FIG. 6. As illustrated in FIGS. 6 and 7, the trap device 1A has a different support member configuration from that of the trap device 1. More specifically, the support member of the trap device 1A lacks the support portion 103 and the supported portion 124, and instead includes a support portion 104 that supports the inner vessel 12 from the bottom portion 120. In the example illustrated in FIGS. 6 and 7, the support portions 104 are four blocks that each have a solid-cylindrical shape. The support portions 104 disposed spaced apart around the circumferential direction of the opening 101 of the trap tank 10. With such a support member, it is also possible to appropriately arrange the inner vessel 12 in the inner space V and secure a sufficient space for gas flow. Note that a support portion 104 may be fixed to either of the bottom-wall portion 100b of the trap tank 10 or the bottom portion 120 of the inner vessel 12, or may not be fixed to either. In some examples the support portions 104 may be connected together by a ring-shaped member or the like. Additionally, the number and shape of the support portions 104 are not particularly limited, and various modifications may be made thereto as appropriate.

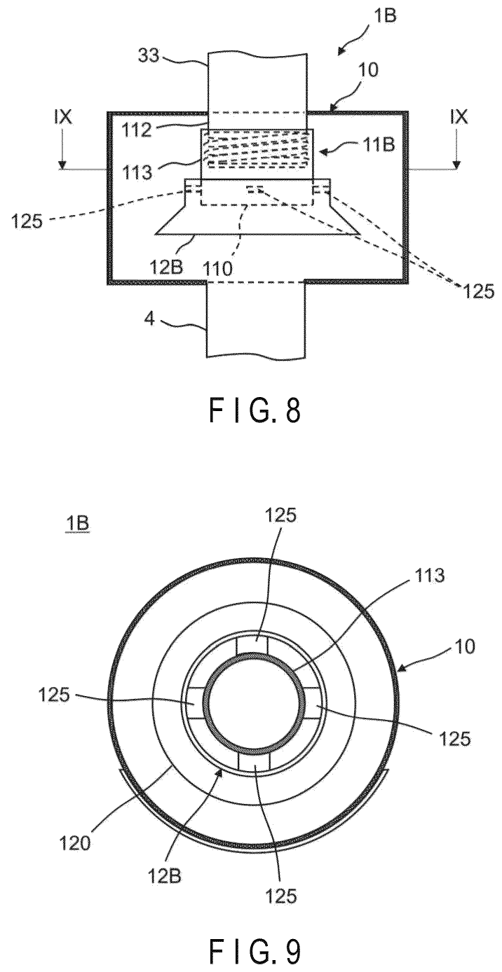

FIG. 8 is a diagram illustrating a configuration of a trap device 1B according to a modification, and FIG. 9 is a IX-IX sectional view of FIG. 8. As illustrated in FIGS. 8 and 9, the trap device 1B includes the tank-internal pipe portion 11B and the inner vessel 12B, each of which has a different configuration from those of the tank-internal pipe portion 11 and the inner vessel 12 in the trap device 1. More specifically, in the trap device 1B, the inner vessel 12B is integrated with the tank-internal pipe portion 11B by inclusion of a connecting portion 125. There are four connecting portions 125 that are formed spaced apart in the circumferential direction on the inner surface of the side-wall portion 121 of the inner vessel 12B. The four connection portions 125 are each connected to the outer surface of the tank-internal pipe portion 11B. In other words, in the trap device 1B, the support member is composed of the connecting portions 125.

Furthermore, the tank-internal pipe portion 11B of the trap device 1B includes a first portion 112 and a second portion 113. The first portion 112 is a portion that continues into the top-wall portion 100a. The first portion 112 may be formed in an integral manner with the tank-external pipe portion 33 in some examples. The second portion 113 includes the open-end portion 110. The second portion 113 is connected to the connecting portion 125. The first portion 112 and the second portion 113 can be removably connected together via a screw mechanism or the like. In the example illustrated in FIG. 8, a threading is formed on the outer-circumferential surface of a far end portion of the first portion 112 and a groove that can be engaged with the threading of the first portion 112 is formed on the inner-circumferential surface of the second portion 113. In this way, the inner vessel 12B can be removed from the first portion 112 along with the second portion 113 and retrieved from the trap tank 10. Note that the first portion 112 and the second portion 113 may removably be connected in any other way than the screw mechanism. Furthermore, in other examples, the groove may be formed in the first portion 112 and the threading may be formed in the second portion 113.

The end face 1210 of the side-wall portion 121 of the inner vessel 12 of an embodiment may be located at same position as the end face 1100 of the open-end portion 110 of the tank-internal pipe portion 11 in the first direction D1. The same applies to the inner vessel 12B.

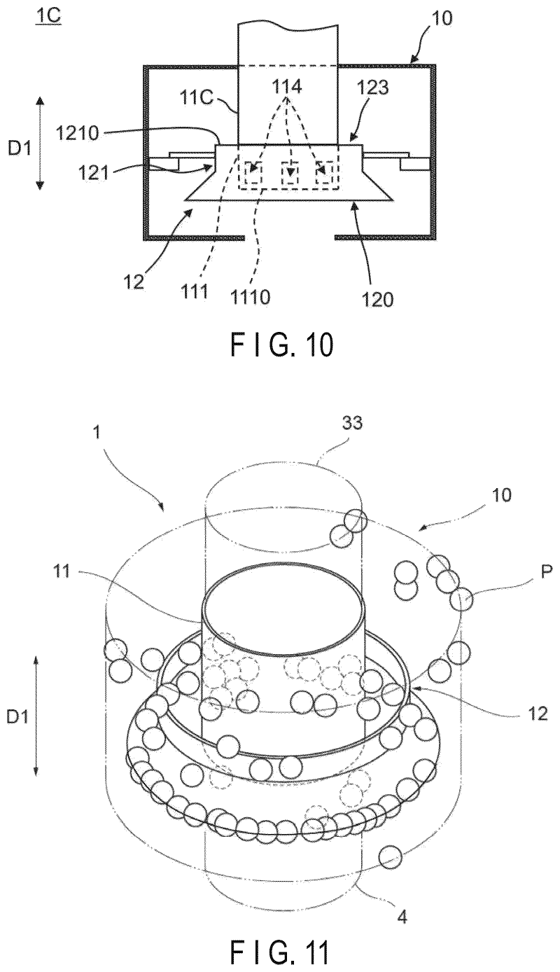

FIG. 10 is a diagram illustrating a configuration of a trap device 1C according to a modification. As illustrated in FIG. 10, the trap device 1C includes a tank-internal pipe portion 11C that has a different configuration from that of the tank-internal pipe portion 11 of the trap device 1. The tank-internal pipe portion 11C includes a circumferential wall 111, extending from the top-wall portion 100a in the first direction D1, and a closed end face 1110 that caps the circumferential wall 111. One or more openings 114 for discharging of gas are formed in the circumferential wall 111 near the closed end face 1110. In the trap device 1C, the inner vessel 12 is disposed so as to surround the circumferential wall 111 such that the side-wall portion 121 is spaced away from the circumferential wall 111. In the trap device 1C, the end face 1210 of the side-wall portion 121 of the inner vessel 12 is located farther away from the bottom portion 120 than the openings 114 in the first direction D1. In other words, in the trap device 1C, the openings 114 are entirely disposed to be within the interior of inner vessel 12. According to the trap device 1C thus configured, it is also possible to improve a collection efficiency for the particles P as in the trap device 1.

In the trap device 1 of an embodiment, the inner vessel 12 need not necessarily be retrievable (removable) from the trap tank 10. That is, a trap tank 10 may be formed without the opening 102 and the lid 100d. The same applies to the trap devices 1A to 1C.

The shape of the trap tank 10 is not limited to the shape depicted in the above examples, and, in general, any modification in shape may be made. For example, the trap tank 10 need not be configured such that the tank-internal pipe portion 11 and the piping system 4 are coaxial or substantially coaxial with each other in their positional relationship.

### 2. Other Embodiments

The present disclosure is not limited to the example embodiments described above. For example, other embodiments are conceivable such as those described below.

The system 6 to which the trap device 1 is applied is not limited to a system that includes the film-forming device 2. For example, instead of a film-forming device 2 may be any other device, such as an etching device, may be adopted. Furthermore, the flow channel including the trap device 1 may be used with other materials besides a gas and particles P, for example, vapor, mist, or the like may flow in the flow channel. The same applies to the trap devices 1A to 1C.

Two or more pump devices 5 may be connected to the piping system 4. In this case, the piping system 4 can be branched after the trap device 1 to connect each pump device 5 for a shared trap device 1. The same applies to the trap devices 1A to 1C.

### Example Operation

Example operations of an embodiment will now be described. The present disclosure is not limited to this example described below.

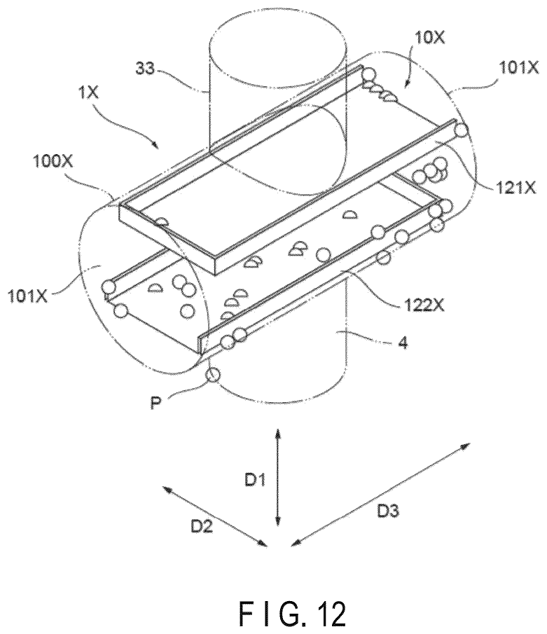

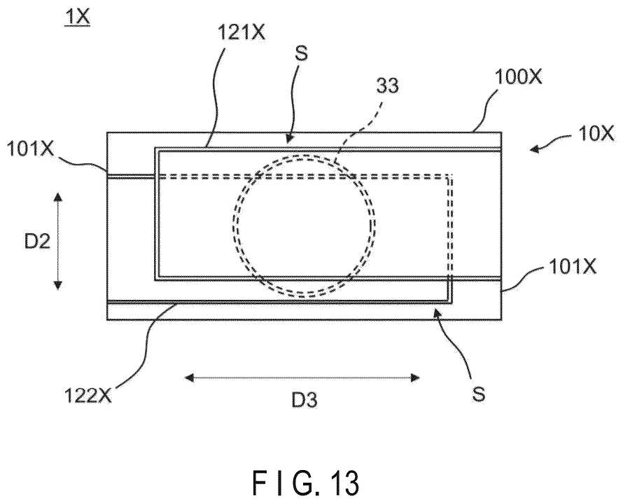

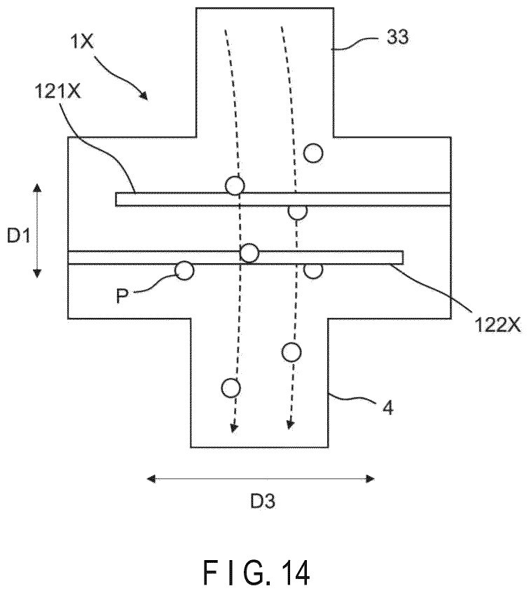

Simulation models for each of the trap device 1 of the embodiment (Example: including the trap devices 1A to 1C) and a comparative trap device 1X (comparative example) were created and the collection efficiency for the particles P [% of total] and the pressure loss for the gas [in Pa] were simulated. FIG. 11 is the schematic model of a trap device 1, in which for facilitating description, the tank-external pipe portion 33, the trap tank 10, and the piping system 4 are each indicated by chain double-dashed lines. The relative sizes of the particles P are enlarged for purposes of description, and the particles P located behind the tank-internal pipe portion 11 or on the side of the outer surface of the bottom portion 120 are indicated by dashed lines. FIG. 12 is the schematic model of the trap device 1X. FIG. 13 is a plan view of the trap device 1X, and FIG. 14 is a diagram for describing the behavior of particles P in the trap device 1X. As illustrated in FIGS. 12 to 14, in the trap device 1X, the axial direction of the tank-external pipe portion 33 and the piping system 4 is set as the first direction D1, and the certain directions perpendicular to the first direction D1 are set as the second direction D2 and the third direction D3.

The trap device 1X includes a trap tank 10X, and a first tray 121X and a second tray 122X provided in the inner space of the trap tank 10X. For facilitating description, in FIG. 12, the tank-external pipe portion 33, the trap tank 10X, and the piping system 4 are each indicated by chain double-dashed lines. Again, the relative sizes of particles P are enlarged. The trap tank 10X includes a side-wall portion 100X that has a hollow-cylindrical shape and extends in the third direction D3 and end-wall portions 101X that close (cap) the opposite ends of the side-wall portion 100X. The side-wall portion 100X is connected to the tank-external pipe portion 33 and the piping system 4. Each of the first tray 121X and the second tray 122X is rectangular in plan view. These trays are provided for receiving the particles P in the trap tank 10X. The first tray 121X is fixed to the inner surface of one of the end-wall portions 101X, and the second tray 122X is fixed to the inner surface of the other one of the end-wall portions 101X. The first tray 121X and the second tray 122X are arranged spaced apart from each other in the first direction D1 such that their positions in the second direction D2 and the third direction D3 are offset from each other.

The first tray 121X and the second tray 122X do not com contact the side-wall portion 100X. In other words, a spacing S (see FIG. 13) is left between the outer edges of the first and second trays 121X and 122X and the side-wall portion 100X in plan view. The first tray 121X and the second tray 122X are disposed such that the length of their mutually overlapping portion in the second direction D2 in plan view is substantially the same as the outer diameter of the tank-external pipe portion 33. Consequently, as illustrated in FIG. 14, it is considered that some of the particles P entering from the tank-external pipe portion 33 into the trap tank 10X will ultimately enter the piping system 4 by passing through the spacing S without being received by the first tray 121X or the second tray 122X.

Assuming a situation in which the gas is constantly introduced from the tank-external pipe portion 33 into the trap device and discharged from the piping system 4, a simulation was conducted under the conditions below:
Flow rate of gas into trap tank [kg/s]: 0.0022 (equivalent to 75000 [sccm])
Absolute pressure in trap tank [Pa]: 50
Analysis duration [s]: 1
Total analysis time [s]: 100
Particle shape: spherical
Particles diameter [μm]: 10
Number of particles injected into trap tank [/s]: 10

The particle-injection positions were set so as to be randomized in the flow channel section of the tank-external pipe portion 33. A total of 1000 particles were injected into the trap tank over the entire analysis time. In this context, units of sccm reflect volumetric flow rates of standard cubic centimeters per minute.

Per the simulation result, the collection efficiency [%] of the simulated example embodiment was 60, whereas that of the simulated comparative example was 16.1. The collection efficiency [%] was calculated based on the total number of particles collected in the inner vessel 12 (example embodiment) or the total number of particles collected in the first tray 121X and the second tray 122X (comparative example) relative to the total number of injected particles (1000). The pressure losses [Pa] fell in the range of 54 to 58 for both examples. From the above-described simulation results, it was confirmed that as compared to the trap device 1X (comparative example), the trap device 1 (simulate example embodiment) had a significantly improved particle collection efficiency while maintaining similar levels of pressure loss.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is

1. A trap device, comprising:
a trap tank wall portion surrounding an interior space, the trap tank wall portion having an inlet side and an outlet side;
a tank-internal pipe portion extending from the trap tank wall portion into the interior space from the inlet side, the tank-internal pipe portion having a first opening portion that opens into the interior space; and
an inner vessel in the interior space, the inner vessel including:
a bottom portion with a bottom surface that faces the first opening portion, the bottom surface being spaced from the first opening portion in a first direction and being between the first opening portion and the outlet side, and
a side-wall portion that extends toward the inlet side from the bottom surface and forms a second opening portion at a position along the first direction that is the same or closer to the inlet side than the first opening portion, wherein
a gas flow space is between the trap tank wall portion and the inner vessel to permit indirect gas flow from the second opening portion to the outlet side.

2. The trap device according to claim 1, wherein the first opening portion and the second opening portion are concentric circles when projected onto a plane parallel to the bottom surface.

3. The trap device according to claim 1, wherein the second opening portion is closer to the inlet side than the first opening portion.

4. The trap device according to claim 1, wherein the side-wall portion includes a tapered portion with an increasing diameter in a second direction perpendicular to the first direction with increasing distance along the first direction from the second opening portion.

5. The trap device according to claim 4, wherein the side-wall portion includes a cylindrical portion between the tapered portion and the second opening portion.

6. The trap device according to claim 1, wherein the trap tank wall portion includes a door permitting the inner vessel to be removed from the interior space.

7. The trap device according to claim 1, further comprising:
a support member supporting the inner vessel in the interior space.

8. The trap device according to claim 1, wherein the tank-internal pipe portion includes a mounting portion and an inlet pipe portion, the inlet pipe portion being detachably connected to the mounting portion.

9. The trap device according to claim 8, wherein the inner vessel is connected to the mounting portion at a portion at or below the second opening portion along the first direction.

10. The trap device according to claim 1, wherein the first opening portion has capped end surface facing the bottom surface and one or more side openings facing in a direction perpendicular to the first direction.

11. The trap device according to claim 1, wherein the side wall portion includes support tabs extending outward toward the trap tank wall portion.

12. The trap device according to claim 11, wherein the trap tank wall portion includes a support structure on which the support tabs rest when the inner vessel is in place in the interior space.

13. The trap device according to claim 1, further comprising:
a plurality of support portions between the outlet side of the trap tank wall portion and the bottom portion of the inner vessel in the first direction.

14. A substrate processing apparatus, comprising:
a processing chamber into which gas flows;
an outlet piping system connected to the processing chamber into which gas from the processing chamber flows;
a trap device connected to an outlet of the outlet piping system, the trap device including:
a trap tank wall portion surrounding an interior space, the trap tank wall portion having a trap inlet side connected to the outlet of the outlet piping system and a trap outlet side;
a tank-internal pipe portion extending from the trap tank wall portion into the interior space from the tank inlet side, the tank-internal pipe portion having a first opening portion that opens into the interior space; and
an inner vessel in the interior space, the inner vessel including:
a bottom portion with a bottom surface that faces the first opening portion, the bottom surface being spaced from the first opening portion in a first direction and being between the first opening portion and the tank outlet side, and
a side-wall portion that extends toward the tank inlet side from the bottom surface and forms a second opening portion at a position along the first direction that is the same or closer to the tank inlet side than the first opening portion, wherein
a gas flow space is between trap tank wall portion and the inner vessel to permit indirect gas flow from the second opening portion to the tank outlet side.

15. The substrate processing apparatus according to claim 14, wherein the first opening portion and the second opening portion are concentric circles when projected onto a plane parallel to the bottom surface.

16. The substrate processing apparatus according to claim 15, wherein the second opening portion is closer to the tank inlet side than is the first opening portion.

17. The substrate processing apparatus according to claim 14, wherein the side-wall portion includes a tapered portion with an increasing diameter in a second direction perpendicular to the first direction with increasing distance along the first direction from the second opening portion.

18. The substrate processing apparatus according to claim 17, wherein the side-wall portion includes a cylindrical portion between the tapered portion and the second opening portion.

19. The substrate processing apparatus according to claim 14, wherein the first opening portion has capped end surface facing the bottom surface and one or more side openings facing in a direction perpendicular to the first direction.

20. The substrate processing apparatus according to claim 14, wherein a pump is connected to the tank outlet side.
